(19) United States
(12) Patent Application Publication
(10) Pub. No.: US 2004/0155729 A1
(43) Pub. Date: Aug. 12, 2004

(54) Multi-bit phase shifter and manufacturing method thereof

(75) Inventors: Young Joon Ko, Seoul (KR); Jae Yeong Park, Seoul (KR)

Correspondence Address: FLESHNER & KIM, LLP, P.O. Box 221200, Chantilly, VA, 20153-1200, US

(73) Assignee: LG ELECTRONICS, INC.

(21) Appl. No.: 10/774,527

(22) Filed: Feb. 10, 2004

(30) Foreign Application Priority Data
Feb. 12, 2003 (KR) 08878/2003

(51) Int. Cl. H01P 3/00; H01P 9/00; H01Q 3/22; H01Q 3/24

(52) U.S. Cl. 333/164; 333/161; 342/371; 342/368; 343/754

(57) ABSTRACT

A multi-bit phase shifter suitably used for a satellite broadcasting and a satellite communication band includes one or a plurality of phase shifters each having a short stub with an end short and an MEMS (Micro Electro Mechanical System) switch formed at the end of the short stub and controlling an impedance value. A processing cost and an insertion loss can be reduced, a driving voltage can be lowered, a wider bandwidth can be obtained, and uniform phase characteristics can be obtained.

### BACKGROUND OF THE INVENTION

1. Field of the Invention

The present invention relates to a phase shifter and, more particularly, to a micro electro mechanical system (MEMS) device, a multi-bit phase shifter adopting a processing technique using the MEMS, and its manufacturing method.

2. Description of the Background Art

A phased array antenna is necessarily used in a communications system, and a phase shifter is a core part of the phased array antenna to control phases of each antenna. The phase shifter uses various types of delay circuits and an electronic switch to perform a phase shifting. Especially, since the advent of an MMIC (Microwave Monolithic Integrated Circuit), which performs a function of removing a phase difference among received signals, an MESFET (Metal Semiconductor Field Effect Transistor) and a varactor diode are used as switches.

In addition, recently, in order to meet the demands for a device that is small, light and integrated with low power consumption at a low cost, an RF/Microwave system employs a low-loss radio frequency (RF) switching device and a variable capacitor using an MEMS (Micro Electro Mechanical System) process.

Currently, an active phase array system used for a satellite broadcasting and satellite communications is constructed by connecting an antenna, a transceiver module, a phase shifter and an attenuator.

A switch employed for the phase shifter uses a pin-diode and a field effect transistor. In this case, as known to a person skilled in the art, the pin-diode consumes 3˜10 mW DC power in one diode and the field effect transistor has a big front-end insertion loss.

Basic structures and operation methods of generally used various phase shifters will now be described.

In general, a phase shifter is a device for delaying for a phase velocity of an inputted signal by using a capacitor or an inductor so that an output terminal can obtain a signal of a desired phase.

FIG. 1A is an exemplary view showing a phase shifter for delaying a phase velocity by switching a transmission line.

As shown in FIG. 1A, the phase shifter can obtain a phase difference between two transmission lines each having a different electrical length by switching them.

FIG. 1B is an exemplary view showing a phase shifter for delaying a phase velocity by a phase difference between an inputted signal and a reflected and outputted signal.

As shown in FIG. 1B, the phase shifter can suitably delays a phase velocity of an input signal by using a phase difference between an inputted signal and a reflected and outputted signal.

FIG. 1C is an exemplary view showing a phase shifter by using the inductor and the capacitor.

As shown in FIG. 1C, the phase shifter increases or decreases a phase velocity by using the inductor and the capacitor. Herein, a transmission line of X/4 is used to partially remove a reactance mismatch.

FIG. 1D is an exemplary view showing a phase shifter by using a phase difference between a low pass filter and a high pass filter.

As shown in FIG. 1D, the phase shifter suitably delays a phase velocity of an input signal by using a phase difference between the low pass filter and the high pass filter.

The above-described four methods are phase delaying methods that are commonly used for the phase shifter and also adopted for basic operations of a background art and the present invention.

A structure and characteristics of a conventional 5-bit MMIC phase shifter lo used in an X band (1˜13 GHz for satellite broadcasting) or in a K band (18˜20 GHz for satellite communications) by using those phase shifters in the four methods are as follows.

FIG. 2 is an exemplary view showing a structure of the X-band MMIC 5-bit phase shifter and a delay circuit.

As shown in FIG. 2, the X-band MMIC 5-bit phase shifter includes 180°/45°/22.5°/11.25°/90° phase shifters, for which the field effect transistor (FET) is used.

The phase shifter employing the field effect transistor will now be described.

First, the 180° and 90° phase shifters have such a structure that a low pass filter and a high pass filter are connected in parallel. Namely, when an FET switch of the low pass filter is turned on, an FET switch of the high pass filter is turned off, so the low pass filter is connected to both input and output terminals. Reversely, when the FET switch of the high pass filter is turned on and connected to the input terminal and the output terminal, the FET switch of the low pass filter is turned off and disconnected from the input and output terminals. Accordingly, by using phase differences in these two cases, 90°/180° phase differences can be obtained.

In addition, the 45°/22.5°/11.25° phase shifters include a spiral inductor and an FET switch. Namely, when a switch is turned off, an inputted signal is phase-delayed by the spiral inductor, and when the switch is turned on, the inputted signal proceeds to an output terminal through the short switch, so no phase delay occurs. Accordingly, the phase shifters can obtain 45°, 22.5° and 11.25° phase differences.

However, conventional phase shifters mostly use a semiconductor device, so they have uniform phase characteristics but a big insertion loss. In addition, since a fabrication process of the semiconductor switch is so complicate that a fabrication cost increases.

FIG. 3A is a graph showing insertion loss characteristics of the phase IS shifter of FIG. 2 and FIG. 3B is a graph showing phase characteristics of the phase shifter of FIG. 2.

The conventional X-band MMIC 5-bit phase shifter has such uniform phase characteristics as shown in FIG. 3B but exhibits an average −7.5 dB insertion loss as shown in FIG. 3A, because it employs the FET semiconductor switch which has a big insertion loss.

FIG. 4A is an exemplary view showing a structure of the K-band MMIC 5-bit phase shifter and a delay circuit.

As shown in FIG. 4A, the K-band MMIC 5-bit phase shifter includes 180°/90°/45°/22.5°/11.25° phase shifters which are divided into three types. However, like the above-described X-band MMIC 5-bit phase shifter, the K-band MMIC 5-bnit phase shifter also includes a semiconductor circuit, so it has complicate circuit construction and fabrication process.

FIG. 4B is a circuit diagram of the 180° phase shifter of FIG. 4A.

As shown in FIG. 4B, in the 180° phase shifter, a high pass filter and a low pass filter are connected in parallel so as to have a 180° phase difference.

FIG. 4C is a circuit diagram of 90°/45°/22.5° phase shifters.

As shown in FIG. 4C, a 3-bit phase shifter aimed for obtaining 90°/45°/22.5° phase differences forms a π-network by using the inductor and the capacitor and is set by bits so as to obtain 90°/45°/22.5°.

The 11.25° phase shifter obtains a phase difference by using only the capacitor.

The above-described K-band MMIC 5-bit phase shifter uses an HEMT (High Electron Mobility Transistor) as a switch. In this case, the K-band MMIC 5-bit phase shifter exhibits an average 5.5 dB or more insertion loss and approximately average 10 dB input/output reflection coefficient. Though having the better insertion loss compared to the phase shifter employing the FET switch, the phase shifter employing the HEMT switch incurs a high expense in its fabrication because it must adopt the complicate semiconductor process.

As stated above, the phase shifter employing the semiconductor switch has problems that the insertion loss is big and the process is complicate. Thus, in order to overcome such disadvantages, there has been proposed a phase shifter employing an MEMS switch which has a low insertion loss and a relatively simple process.

FIG. 5A is an exemplary view showing a 4-bit phase shifter using the MEMS switch, and FIG. 5B is a graph showing phase characteristics of the 4-bit phase shifter.

As shown in FIG. 5A, four 4-bit phase shifters 22.5°/45°/90°/180° are constructed by using a reference line positioned as a lower portion of a switch and a line with a specific length positioned at an upper portion of the switch, and respectively use a phase shifting method through a delay according to a difference between line lengths. Each line has 22.5°/45°/90°/180° phase differences in the electric length for a reference line, and a desired phase difference can be obtained by suitably turning on/off the switch.

The 4-bit phase shifter is designed as a phase passive array system that is used by being directly connected to an antenna and employs a capacitive loaded MEMS switch, so it has a low insertion loss and simple construction.

As shown in FIG. 5B, the 4-bit phase shifter cannot obtain uniform characteristics in the band for the satellite broadcasting (that is, 10˜13 GHz, X band) or in the band for the satellite communications (18˜20 GHz, K band). In other words, the 4-bit phase shifter has such phase characteristics as to be suitable for a wide band (DC˜20/40 GHz) system and cannot be applied for the satellite broadcasting system or the satellite communications system. In addition, a driving voltage of the switch is 98V, too high to be applied for the satellite broadcasting system.

Besides the above-described 4-bit phase shifter, a reflection type X-band phase shifter also uses the RF MEMS switch. However, this phase shifter also does not have a uniform phase difference (for example, there is a 10° or more difference), and its driving voltage is 30˜40 FV, relatively high.

As mentioned above, when the conventional phase shifter employs the semiconductor switch, because its fabrication process is complicate, the fabrication cost is high and the insertion loss is big. In addition, when the conventional phase shifter employs the MEMS switch, it can hardly obtain uniform phase characteristics, can be hardly applied for the phase shifter for the satellite broadcasting or for the satellite communications because of the high driving voltage, and has a low efficiency.

### SUMMARY OF THE INVENTION

Therefore, an object of the present invention is to provide a multi-bit phase shifter capable of reducing a process cost and an insertion loss by using an MEMS switch, lowering a driving voltage by adopting a DC bias line, connecting an open stub and a short stub in parallel, and obtaining uniform phase characteristics by adopting an air gap coupler, and its manufacturing method.

To achieve these and other advantages and in accordance with the i 5 purpose of the present invention, as embodied and broadly described herein, there is provided a multi-bit phase shifter includes one or more phase shifters each including a short stub with an end short; and an MBMS (Micro Electro Mechanical System) switch formed at the short stub and controlling an impedance value.

To achieve the above objects, there is also provided a method for manufacturing a multi-bit phase shifter including: a first step of forming a first conductive film pattern making a signal line on a substrate, an insulation film pattern on the first conductive film pattern, and forming a resistor pattern along a DC bias line; a second step of sequentially forming a first photoresist pattern, a seed layer and a second photoresist pattern on the resulting structure, and forming an electrode through the seed layer; a third step of removing the second photoresist pattern, etching a portion of the seed layer to form a switch pattern and removing the remaining portion of the seed layer; and a fourth step of forming a third photoresist pattern on the resulting structure, forming a conductive film stacking pattern on the third photoresist pattern to form an air bridge and an air coupler, and removing the photoresist.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1A is an exemplary view showing a phase shifter for delaying a phase velocity by switching a transmission line;

FIG. 1B is an exemplary view showing a phase shifter for delaying a phase velocity according to a phase difference between an inputted signal and a reflected and outputted signal;

FIG. 1C is an exemplary view showing a phase shifter using an inductor and a capacitor;

FIG. 1D is an exemplary view showing a phase shifter using a phase difference between a low pass filter and a high pass filter;

FIG. 2 is an exemplary view showing a structure of an X-band MMIC 5-bit phase shifter and a delay circuit;

FIG. 3A is a graph showing insertion loss characteristics of the phase shifter of FIG. 2;

FIG. 3B is a graph showing phase characteristics of the phase shifter of FIG. 2;

FIG. 4A is an exemplary view showing a structure of a K-band MMIC 5-bit phase shifter and a delay circuit;

FIG. 4B is a circuit diagram showing a 180° phase shifter;

FIG. 4C is a circuit diagram of 90°/45°/22.5° phase shifters of FIG. 4A;

FIG. 5A is an exemplary view showing a 4-bit phase shifter using an MEMS switch;

FIG. 5B is a graph showing phase characteristics of the 4-bit phase shifter of FIG. 5A;

FIG. 6A is an exemplary view showing a 5-bit phase shifter using an MEMS switch in accordance with a preferred embodiment of the present invention;

FIG. 6B is an exemplary view showing an actual photo of a device of FIG. 6A;

FIG. 7 is an exemplary view showing a basic structure of 11.25°/22.5°/45° phase shifters;

FIG. 8 is an exemplary view showing a basic structure of 180°/90° phase shifters;

FIG. 9 is an exemplary view showing a coupler used for the 180°/90° phase shifters;

FIG. 10A is a graph showing an insertion loss and reflection loss characteristics of an X-band (10˜13 GHz) 5-bit phase shifter;

FIG. 10B is a graph showing phase characteristics of the X-band (10˜13 GHz) 5-bit phase shifter;

FIG. 10C is a graph showing insertion loss and reflection loss characteristics of a K-band (18˜20 GHz) 5-bit phase shifter;

FIG. 10D is a graph showing phase characteristics of the K-band (18˜20 GHz) 5-bit phase shifter; and

FIGS. 11A to 11G are sectional views of a manufacturing process of the phase shifter in accordance with the preferred embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

A multi-bit phase shifter including one or more connected phase shifters each having a short stub with an end short and an MEMS (Micro Electro Mechanical System) switch formed at an end of the short stub and controlling an impedance value and its manufacturing method in accordance with a preferred embodiment of the present invention will now be described.

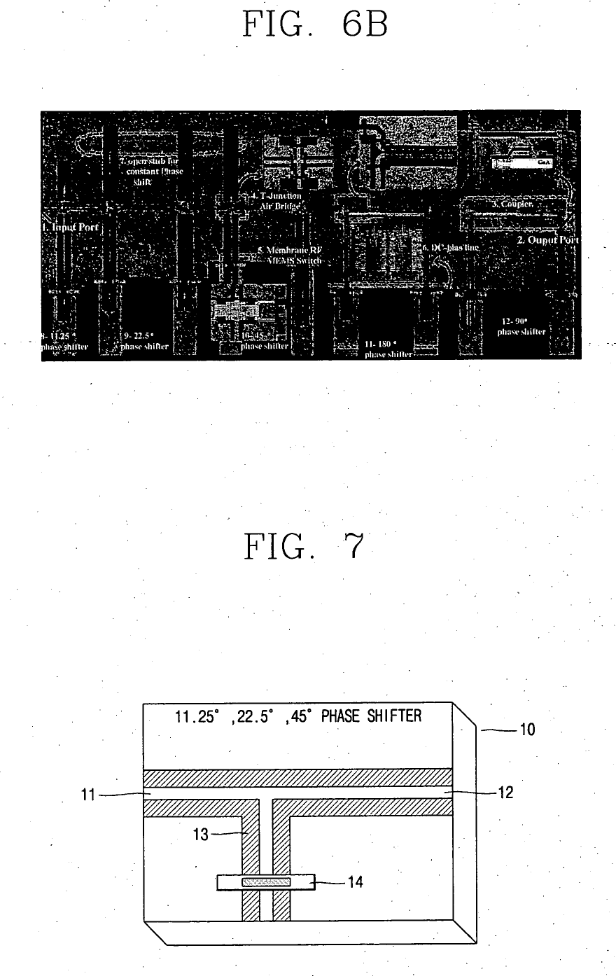

FIG. 6A is an exemplary view showing a 5-bit phase shifter using an MEMS switch in accordance with a preferred embodiment of the present invention.

As shown in FIG. 6A, the phase shifter in accordance with the present invention can be applied for a satellite broadcasting and satellite communications. A signal applied to an input port 1 passes through 11.25°/22.5°/45° phase shifters and is outputted to an output port 2 through 180°/90° phase shifters.

In detail, referring to the 11.25° phase shifter, first, on the basis of a signal line connected to the input port 1, open stubs 7 are positioned at an upper side and short stubs 9 are disposed at a lower side. Accordingly, since the open stubs 7 and the short stubs 9 are disposed in parallel, a wider bandwidth can be obtained. At this time, the open stub 7 and the short stub 9 are connected by a T-junction air bridge 4. Namely, the T-junction air bridge 4 is used to form a common ground by connecting grounds.

An MEMS switch 5 is formed at an end of the short stub 9 and a DC-bias line 6 is formed to be concavo-convex in order to lower the switch driving voltage. The DC bias line 6 is a signal line having resistibility, of which one side is connected to the MEMS switch 5 and the other side is connected to a switch pad 8, which applies a switch control signal. In FIG. 6A, the switch signal line of the 11.25° phase shifter is separated, which, however, can be constructed differently according to a designing method.

When a control voltage is applied to the switch pad 8 or to the switch signal line, the corresponding control voltage drives the MEMS switch 5 after passing through the DC bias line, and the open stub 7 serves as a capacitor and delays an input signal. At this time, a phase difference is determined by a capacitance on/off ratio by manipulation of the MEMS switch 5.

Like the 11.25 phase shifter, the 22.5°/45° phase shifters suitably adjust the length of the stub and the length of the DC bias line and forms a phase difference by connecting the stub and the DC bias line in an overlap manner.

The 180° phase shifter and the 90° phase shifters also create a phase difference by controlling the capacitance on/off ratio by using the short stub 9 and the MEMS switch 5, for which they connect phase shifting parts, except for the open stub, with the air gap coupler 3. Namely, the 180°/90° phase shifters can have a stable phase difference by virtue of the air gap coupler 3.

FIG. 6B is an exemplary view showing an actual photo of a device of FIG. 6A.

As shown in FIG. 6B, the phase shifter in accordance with the preferred embodiment of the present invention has such a simple structure as to be easily designed and implemented.

To sum up, since the 5-bit phase shifter using the MEMS switch uses the MEMS switch, the insertion loss is small and the process is simple, and in addition, use of the stubs betters phase characteristics and use of the air gap coupler maintains the stable phase difference. Moreover, because the DC bias line is formed as a resistor, the MEMS switch driving voltage is lowered to 15˜20V. Furthermore, thanks to the simple structure, the 5-bit phase shifter can be easily designed and implemented.

FIG. 7 is an exemplary view showing a basic structure of 11.25°/22.5°/45° phase shifters.

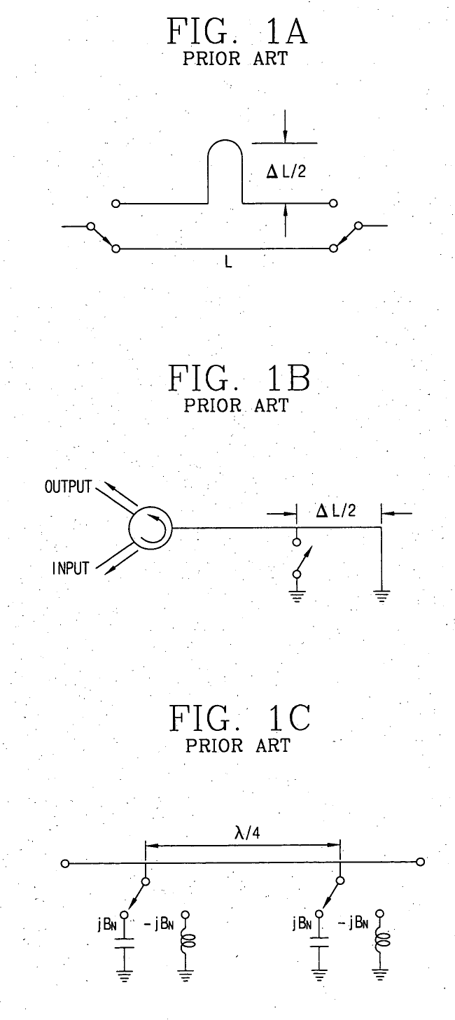

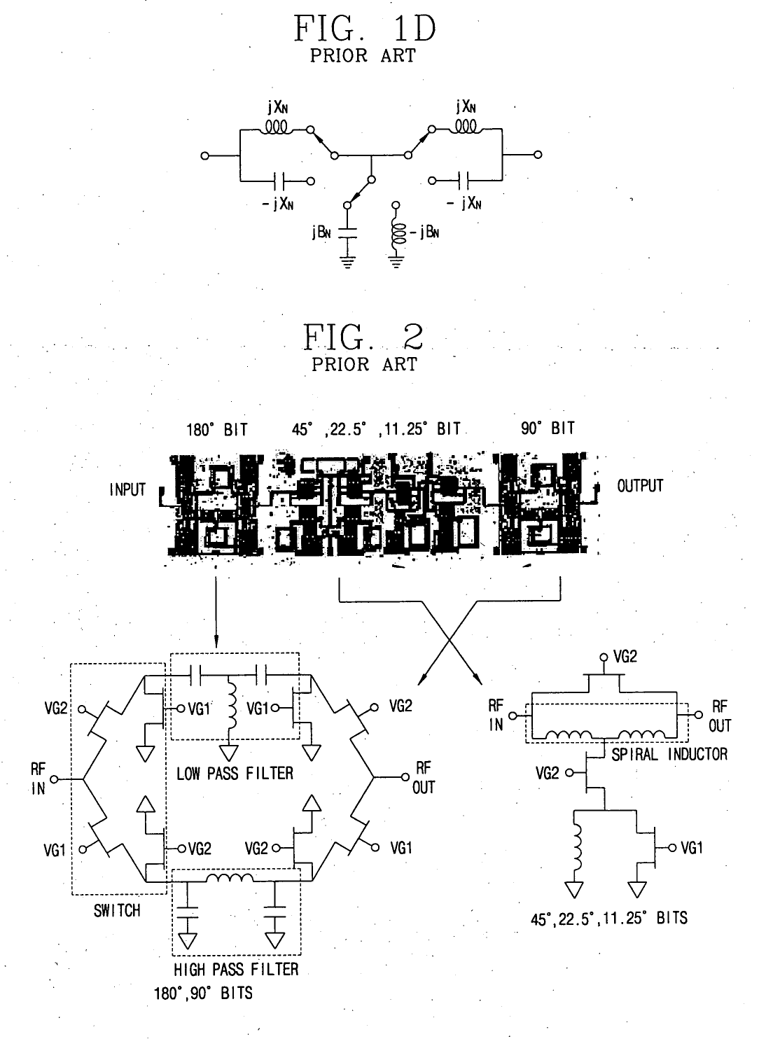

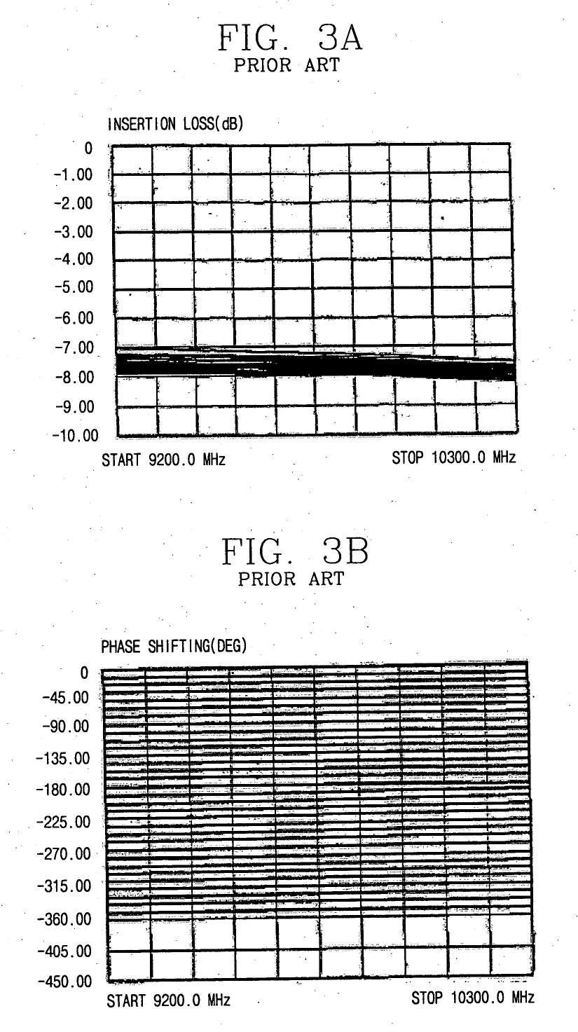

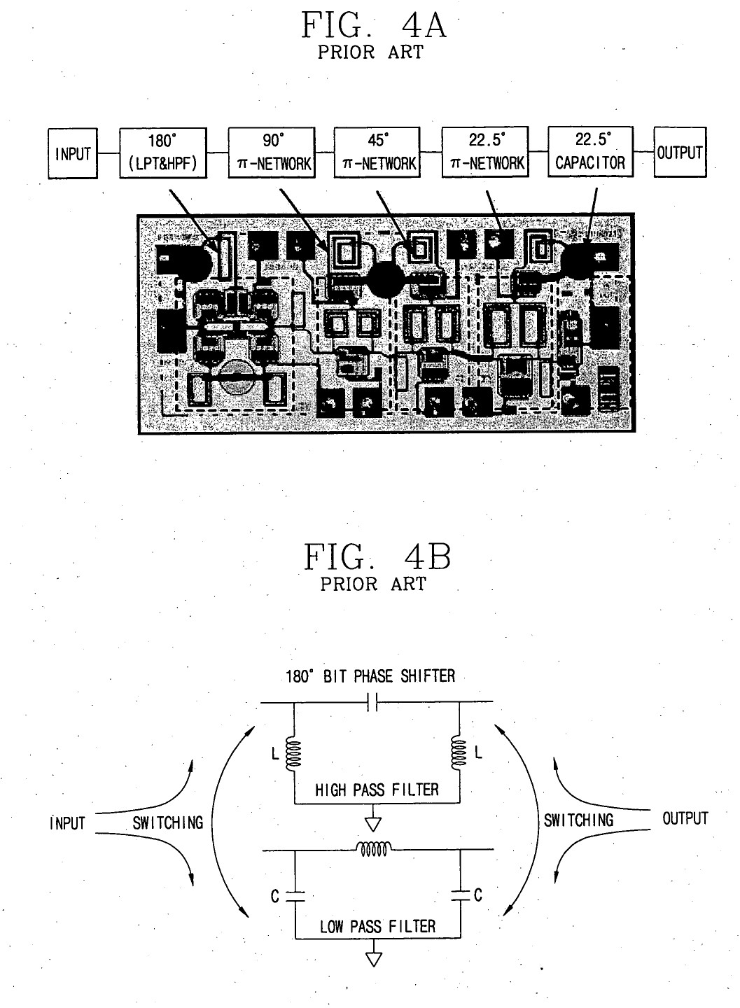

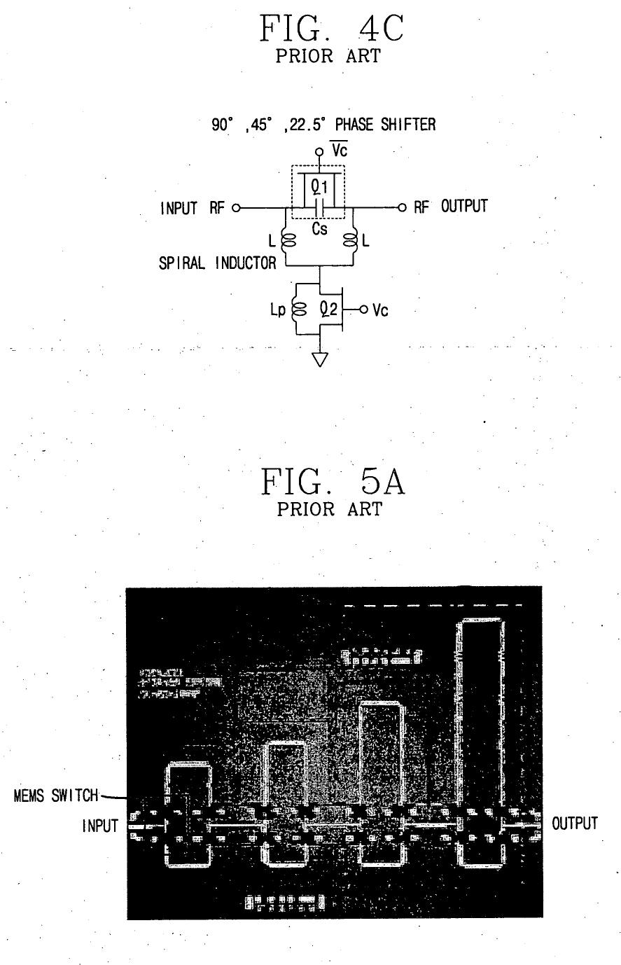

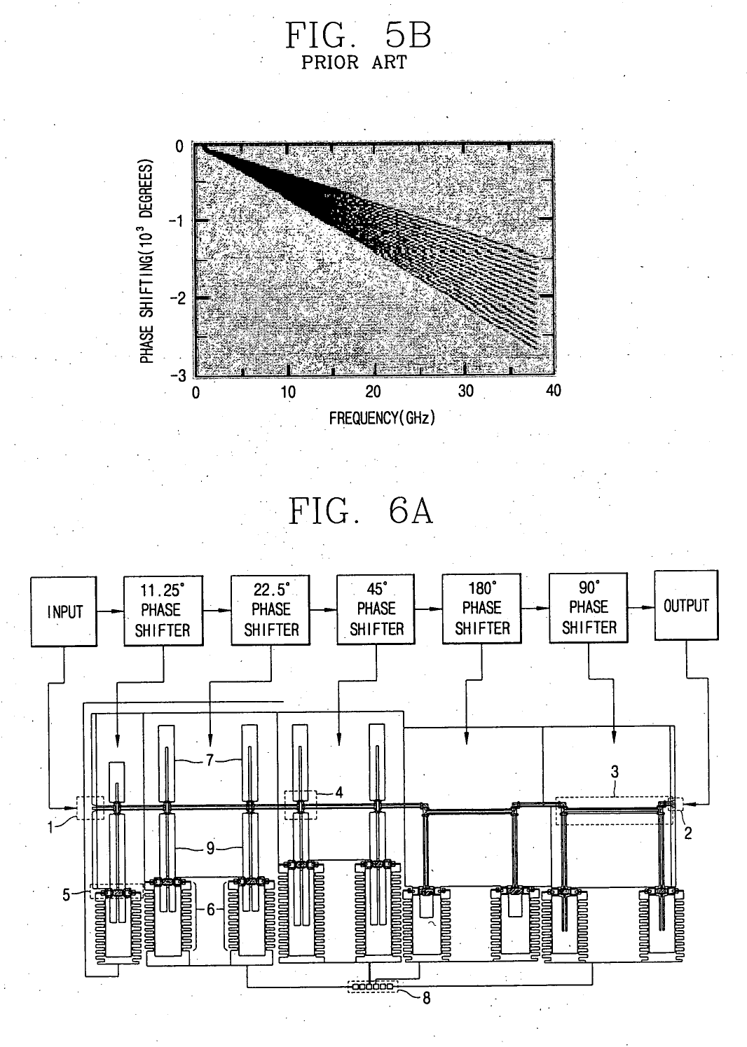

As shown in FIG. 7, in the 11.25°/22.5°/45° phase shifters, the short stubs 13 with a portion of the end short are formed in parallel at a transmission line between the input part 11 and an output part 12, and the MEMS switch 14 is connected to the end. The short stub 13 operates as a capacitor by manipulation of the MEMS switch 14 to delay a phase of an inputted signal. Comparatively, in the conventional art with reference to FIG. 1C, the inductor or the capacitor is added in parallel to the transmission line to delay a phase, but in the present invention, the short stub 13 is substitutively used as the capacitor. Since an impedance value viewed from the stub with the end short is determined by the ON/OFF ratio of the MEMS switch 14, a change in the impedance value changes the phase of the input signal to 11.25°/22.5°/45°.

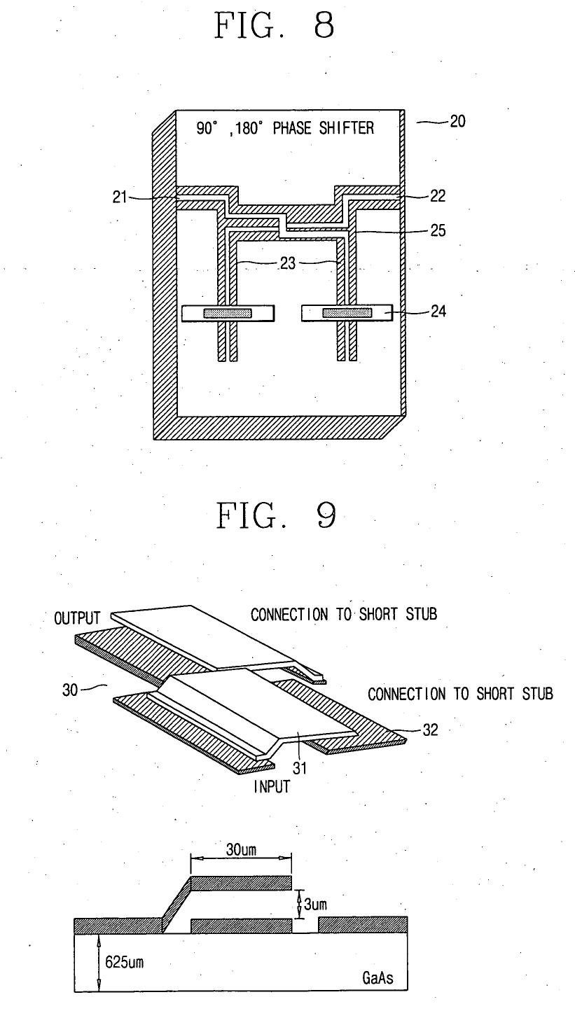

FIG. 8 is an exemplary view showing a basic structure of 180°/90° phase shifters.

As shown in FIG. 8, the 180°/90° phase shifters include two phase shifting parts that are connected by an air coupler. In the 180°/90° phase shifters, short stubs 23 are connected in parallel and MEMS switches 24 are connected to each end of the short stubs 23. Namely, like the case in FIG. 7, an impedance value viewed from the stub with the end short is determined by the ON/OFF ratio of the MEMS switches 224. The MEMS switches 24 are turned on/off by the same control signal.

FIG. 9 is an exemplary view showing a coupler used for the 180°/90° phase shifters.

As shown in FIG. 9, the coupler is the air gap coupler, including a lower metal part 32 and an upper metal part 31. Since the coupler has a stable phase difference, it enhances the phase characteristics. Namely, in the air gap coupler, the lower metal and the upper metal are isolated with a certain space therebetween and these structures are formed to be diagonally symmetrical. Each metal part is connected to the short stub.

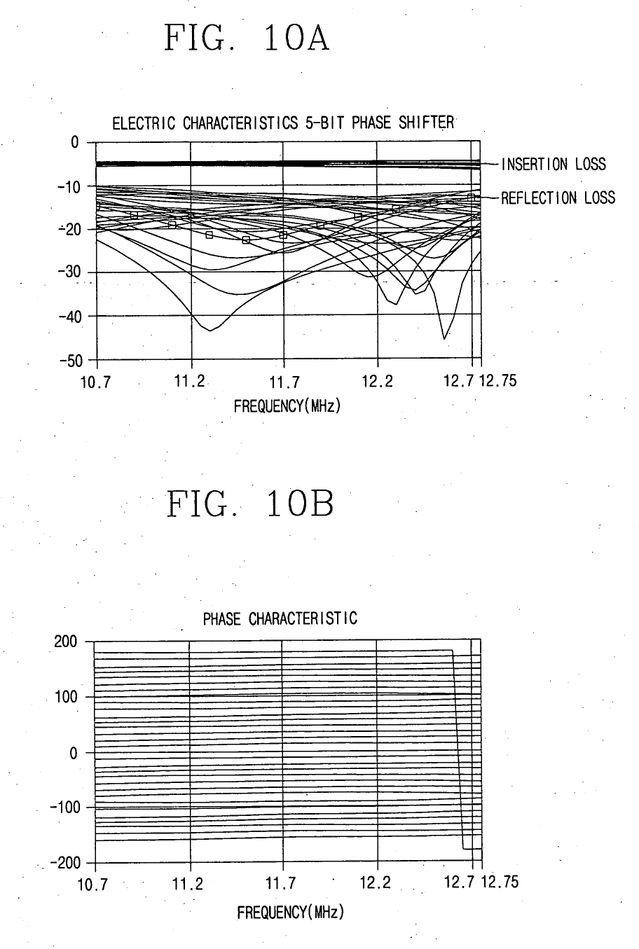

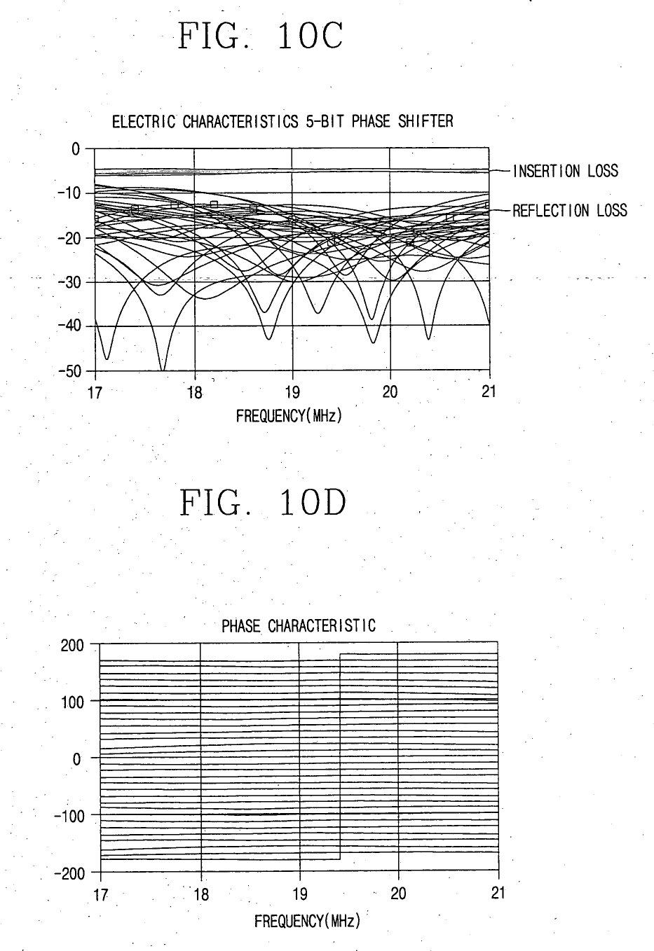

FIG. 10A is a graph showing an insertion loss and reflection loss characteristics of an X-band (10˜13 GHz) 5-bit phase shifter, and FIG. 10B is a graph showing phase characteristics of the X-band (10˜13 GHz) 5-bit phase shifter.

As shown in FIGS. 10A and 10B, the X-band 5-bit phase shifter in accordance with the preferred embodiment of the present invention exhibits an average 4.5 dB insertion loss and a minimum reflection loss of 10 dB, which shows about 3 dB improvement compared to the conventional phase shifter using the semiconductor device.

Referring to phase characteristics, a phase difference in the 11.25° phase characteristics is less than 3°, which shows an obvious improvement effect of the present invention. Thus, the phase shifter in accordance with the present invention has an excellent performance for the satellite broadcasting.

FIG. 10C is a graph showing insertion loss and reflection loss characteristics of a K-band (18˜20 GHz) 5-bit phase shifter, and FIG. 10D is a graph showing phase characteristics of the K-band (18˜20 GHz) 5-bit phase shifter.

As shown in FIGS. 10C and 10D, the K-band 5-bit phase shifter exhibits an average 4.5 dB insertion loss and a minimum reflection loss of less than 10 dB. Referring to phase characteristics, a phase error in the phase characteristics is less than 30, showing an obvious improvement effect. Thus, the phase shifter of the present invention has an excellent performance for satellite communications.

In addition, remarkably, the MEMS switch used in the present invention is driven at a low voltage of 15˜20V, so that it is favored to be actually applied.

A method for manufacturing the phase shifter will now be described.

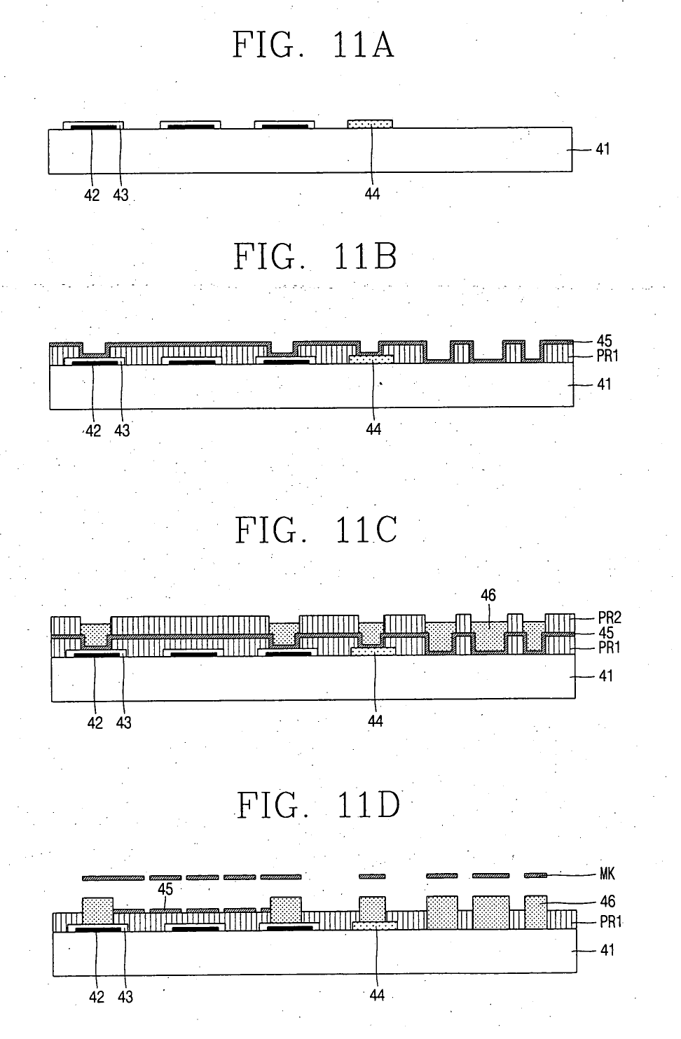

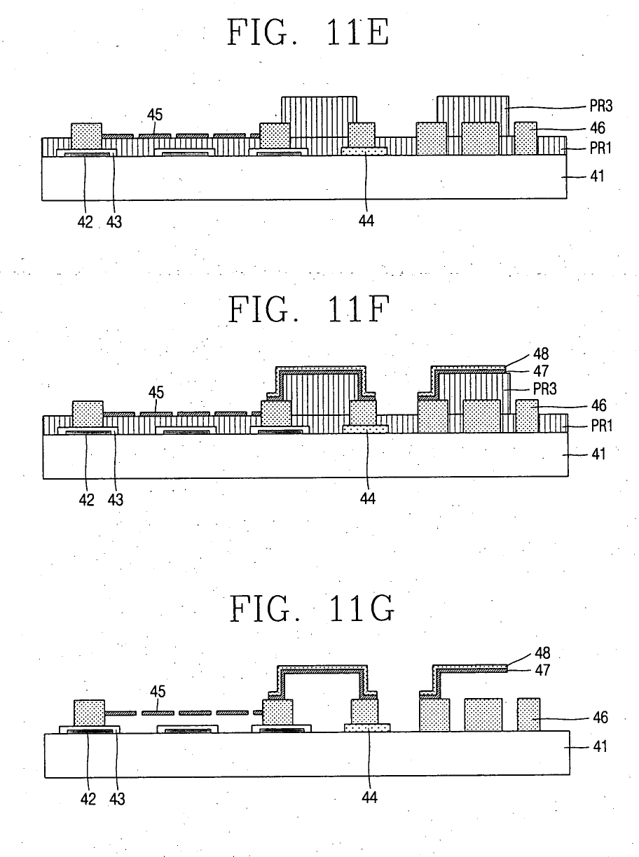

FIGS. 11A to 11G are sectional views of a manufacturing process of the phase shifter in accordance with the preferred embodiment of the present invention.

As shown in FIGS. 11A to 11G, the manufacturing process of the phase shifter includes: a step of forming a first conductive film 42 pattern making a signal line on a substrate 41, forming an insulation film 43 pattern on the first conductive film 42 pattern, and forming a resistor 44 pattern along a DC bias line (FIG. 11A); a step of forming a first photoresist pattern PR1 on the resulting structure and forming a seed layer 45 on the first photoresist pattern PR1 (FIG. 11B); a step of forming a second photoresist pattern PR2 the same as the first photoresist pattern PR1 on the seed layer 45 and forming an electrode 45 by using the seed layer 45 (FIG. 11C); a step of removing the second photoresist pattern PR2 and etching one portion of the seed layer 45 by using a chrome mask (MK) to form a switch pattern and removing the other remaining portion (FIG. 11D); a step of forming a third photoresist pattern PR3 on a region of the resulting structure where an air bridge and an air coupler are formed (FIG. 11E); a step of sequentially forming a second conductive film 47 and a third conductive film 48 on the resulting structure and patterning the conductive films 47 and 48 according to the structures of the air bridge and the air coupler (FIG. 11F); and a step of removing both the first photoresist pattern PR1 and the third photoresist pattern PR3 of the structure (FIG. 11G).

The method will now be described in detail.

As shown in FIG. 11A, Cr/Pt is formed on the substrate 41 and patterned to form the first conductive film 42 making a signal line, and then, in order to protect the first conductive film 42 pattern, an AlN insulation film 43 pattern is formed on the first conductive film 42 pattern.

Next, TaN or Nichrome is formed on the resulting structure and patterned along a DC bias line to form a resistor 44 pattern.

Thereafter, as shown in FIG. 11B, the first photoresist pattern PR1 is formed on the resulting structure to form a basic molding for forming an electrode, on which an Au/Cr seed layer 45 is formed. This is because Au for forming the electrode is formed through a gold plating process. A portion of the seed layer 45 is used as a hinge pattern of the MEMS switch afterward.

And then, as shown in FIG. 11C, the second photoresist pattern PR2 the same as the first photoresist pattern PR1 is formed on the seed layer 45 to complete a photoresist molding for forming the electrode 46, and an Au electrode 46 is formed by using the molding structure and the seed layer 45.

Subsequently, as shown in FIG. 11D, the second photoresist pattern PR2 is removed, and then, a chrome mask (MK) is applied to protect the electrode 46 and one portion of the seed layer 45 is formed as a hinge pattern of the MEMS switch and the other remaining portion is removed.

Thereafter, as shown in FIG. 11E, a third photoresist pattern PR3 is formed on a region of the resulting structure where the air bridge and the air coupler are formed. The third photoresist pattern PR3 exposes portions of electrodes to which the air bridge and the air coupler are connected.

And then, as shown in FIG. 11F, the second conductive film 47, the third conductive film 48 are sequentially formed on the resulting structure, and then, the conductive films 47 and 48 are patterned according to the structure of the air bridge and the air coupler. The second conductive film 47 and the third conductive film 48 are made of different materials, and preferably contain Au.

And, as shown in FIG. 11G, the first photoresist pattern PR1 and the third photoresist pattern PR3 are all removed to secure a region in which the hinge structure 45 of the MEMS switch can operate by the lower signal line 42.

Therefore, as stated above, the MEMS switch can be formed with a simple process compared to the general semiconductor switch fabrication process.

As so far described, the multi-bit phase shifter in accordance with the present invention includes a first phase shifter having the short stub with the end short, the open stub for smoothing phase characteristics, the MEMS switch formed at the end of the short stub and controlling an impedance value, and the DC bias line for lowering a driving voltage of the MEMS switch; and a second phase shifter having the short stub with the end short, the MEMS switch formed at the end of the short stub and controlling an impedance value and the DC bias line for lowering the driving voltage of the MEMS switch.

The 5-bit phase shifter in accordance with the present invention includes a 11.25° phase shifter having one first phase shifter, a 22.5° phase shifter having two first phase shifters, a 45° phase shifter having two first phase shifters, a 90° phase shifter having the second phase shifter, and a 180° phase shifter having the second phase shifter.

Therefore, a process cost and an insertion loss can be reduced by using the MEMS switch, a driving voltage is lowered by adopting the DC bias line, the open stub and the short stub are connected in parallel, and uniform phase characteristics can be obtained by adopting the air gap coupler. Thus, the performance of the phase shifter suitably used for the satellite broadcasting and the satellite communication band can be considerably enhanced for a reduced cost.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A multi-bit phase shifter comprises:
one or more phase shifters each including a short stub with an end short; and
an MEMS (Micro Electro Mechanical System) switch formed at the short stub and controlling an impedance value.

2. The multi-bit phase shifter of claim 1 further comprising:
an open stub connected to the short stub in parallel to obtain a wider bandwidth and smoothing phase characteristics; and
a DC bias line for lowering a driving voltage of the MEMS switch.

3. The multi-bit phase shifter of claim 1 further comprising:
an air gap coupler for maintaining a stable phase difference on a line.

4. The multi-bit phase shifter of claim 1, wherein the phase shifter generates a phase difference by a multiple of 11.25°.

5. The multi-bit phase shifter of claim 1, wherein the phase shifter is 11.25°/22.5°/45°/180°/90° phase shifters.

6. The multi-bit phase shifter of claim 5, wherein the 11.25°/22.5°/45° phase shifters include a stub with an end short, instead of an inductor or a capacitor, and loads the MEMS switch at the end of the stub to use a phase difference of a reflected wave according to a capacitor on-off ratio.

7. The multi-bit phase shifter of claim 5, wherein the 180°/90° phase shifters are reflection type phase shifters using a coupler.

8. The multi-bit phase shifter of claim 5 further comprising:
an air bridge for forming a common ground among grounds of the phase shifters.

9. A multi-bit phase shifter comprising:
a first phase shifter including a short stub with an end short, an open stub for smoothing phase characteristics, an MEMS (Micro Electro Mechanical System) switch formed at the end of the short stub and controlling an impedance value, and a DC bias line for lowering a driving voltage of the MEMS switch; and
a second phase shifter including a short stub with an end short, an MEMS switch formed at the end of the short stub and controlling an impedance value, and a DC bias line for lowering a driving voltage of the MEMS switch.

10. The multi-bit phase shifter of claim 9, wherein, as for the first phase shifter, one or more first phase shifters are connected to generate a phase difference by a multiple of 11.25°.

11. The multi-bit phase shifter of claim 9, wherein the second phase shifter generates a phase difference by a multiple of 90° by controlling the MEMS switches.

12. The multi-bit phase shifter of claim 9, wherein the second phase shifter further includes an air gap coupler for maintaining a stable phase difference among the short stubs.

13. The multi-bit phase shifter of claim 9, wherein the open stub is connected in parallel to the short stub in order to secure a wide bandwidth.

14. The multi-bit phase shifter of claim 9 further comprising:
an air bridge for forming a common ground between grounds of the first phase shifter and the second phase shifter.

15. The multi-bit phase shifter of claim 9, wherein the phase shifter includes a 5-bit phase shifter including a 11.25° phase shifter having one first phase shifter, a 22.5° phase shifter having two first phase shifters, a 45° phase shifter having two first phase shifters, a 90° phase shifter having the second phase shifter, and a 180° phase shifter having the second phase shifter.

16. A method for manufacturing a multi-bit phase shifter comprising:
a first step of forming a first conductive film pattern making a signal line on a substrate, an insulation film pattern on the first conductive film pattern, and forming a resistor pattern along a DC bias line;
a second step of sequentially forming a first photoresist pattern, a seed layer and a second photoresist pattern on the resulting structure, and forming an electrode through the seed layer;
a third step of removing the second photoresist pattern, etching a portion of the seed layer to form a switch pattern, and removing the remaining portion; and
a fourth step of forming a third photoresist pattern on the resulting structure, forming a conductive film stacking pattern on the third photoresist pattern to form an air bridge and an air coupler, and removing the photoresist.

17. The method of claim 16, wherein, in the first step, Cr/Pt is formed on the substrate and patterned to form a first conductive film pattern making the signal line and an AlN insulation film pattern is formed on the first conductive film pattern, on which TaN or Nichrome is formed and a resistor pattern is formed along the DC bias line.

18. The method of claim 16, wherein, in the second step, the first photoresist pattern is formed to form a basic molding for formation of an electrode, on which Au/Cr seed layer is formed, on which the second photoresist pattern the same as the first photoresist pattern is formed to form a photoresist molding for formation of an electrode, and Au electrode is formed by using the molding structure and the seed layer.

19. The method of claim 16, wherein, in the third step, after the second photoresist pattern (PR2) is removed, a chrome mask (MK) is applied and a portion of the seed layer is formed in a hinge pattern of the MEMS switch.

20. The method of claim 16, wherein, in the fourth step, in forming the third photoresist pattern, portions of each electrode to which the air bridge and the air coupler are connected are exposed, the second conductive film and the third conductive film are sequentially formed on the resulting structure, a patterning is formed according to the structure of the air bridge and the air coupler, and then, the first photoresist pattern and the third photoresist pattern formed in the structure are all removed.
